(19) United States
(12) Patent Application Publication
(10) Pub. No.: US 2025/0314772 A1
(43) Pub. Date: Oct. 9, 2025

(54) Localization of an Artificial Reality System Using Corners in a Real-World Space

(71) Applicant: Meta Platforms Technologies, LLC, Menlo Park, CA (US)

(72) Inventors: Lu ZHOU, San Francisco, CA (US); James Alexander VALORI, San Francisco, CA (US); Joel Amado HESCH, Los Altos Hills, CA (US); Yoav GOLDSTEIN, Menlo Park, CA (US); Andrea Alejandra COHEN, Redwood City, CA (US); Dhwaj AGRAWAL, Redwood City, CA (US); Calvin RIEN, Los Angeles, CA (US)

(21) Appl. No.: 18/629,391

(22) Filed: Apr. 8, 2024

(51) Int. Cl. G01S 17/89; G06T 19/00

(52) U.S. Cl. CPC G01S 17/89; G06T 19/006

(57) ABSTRACT

Aspects of the present disclosure relate to more accurate and quicker localization of an artificial reality (XR) system in a real-world space (e.g., a room). If a user enters a room and localization fails, the system can locate a corner that was designated in a previous localization. The corner could have been manually selected by the user or could have been automatically recommended by the XR system. In some implementations, the user or system can identify two adjacent corners in the room for further accuracy. Through later selection of the corner(s) for localization, the XR system can identify the saved room using depth sensors, with identification of corners being more reliable and detectable than other methods identifying walls.

### TECHNICAL FIELD

The present disclosure is directed to localization of an artificial reality (XR) system using designated corners in a room of a real-world environment.

### BACKGROUND

Artificial reality (XR) devices are becoming more prevalent. As they become more popular, the applications implemented on such devices are becoming more sophisticated. Mixed reality (MR) and augmented reality (AR) applications can provide interactive three-dimensional (3D) experiences that combine images of the real-world with virtual objects, while virtual reality (VR) applications can provide an entirely self-contained 3D computer environment. For example, an MR or AR application can be used to superimpose virtual objects over a real scene that is observed by a camera. A real-world user in the scene can then make gestures captured by the camera that can provide interactivity between the real-world user and the virtual objects. AR, MR, and VR (together XR) experiences can be observed by a user through a head-mounted display (HMD), such as glasses or a headset. An HMD can have a pass-through display, which allows light from the real-world to pass through a lens to combine with light from a waveguide that simultaneously emits light from a projector in the HMD, allowing the HMD to present virtual objects intermixed with real objects the user can actually see.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5 is a flow diagram illustrating a process used in some implementations of the present technology for establishing a designated corner for localization by an artificial reality (XR) system in a real-world space.

FIG. 6 is a flow diagram illustrating a process used in some implementations of the present technology for recovering a real-world space using a previously designated corner.

FIG. 7A is a conceptual diagram illustrating an example view, on an XR system, of a real-world space scanned by the XR system for localization.

FIG. 7B is a conceptual diagram illustrating an example view, on an XR system, of a user interface element prompting selection of a semantic label for a real-world space scanned by the XR system.

FIG. 7C is a conceptual diagram illustrating an example view, on an XR system, of a selection of a corner of a real-world space to designate for localization.

FIG. 8A is a conceptual diagram illustrating an example view, on an XR system, of a user interface element prompting selection of a semantic label for a real-world space unrecognized by the XR system.

FIG. 8B is a conceptual diagram illustrating an example view, on an XR system, of a user interface element prompting selection of a previously designated corner in a real-world space.

FIG. 8C is a conceptual diagram illustrating an example view, on an XR system, of a localized real-world space identified via selection of a previously designated corner.

FIG. 8D is a conceptual diagram illustrating an example view, on an XR system, of virtual objects rendered relative to localization data obtained for a real-world space.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure provide more accurate, quicker localization of an artificial reality (XR) system in a real-world space (e.g., a room). If a user enters a room and localization fails, the system can locate a corner that was designated in a previous localization. The corner could have been manually selected by the user or could have been automatically recommended by the XR system. In some implementations, the user or system can identify two adjacent corners in the room for further accuracy. Through later selection of the corner(s) for localization, the XR system can identify the saved room using depth sensors, with identification of corners being more reliable and detectable than other methods that identify walls.

For example, when activating or donning an XR system in a room unknown to the XR system, a user can scan the real-world space with the XR system to generate a three-dimensional (3D) mesh representing the space, e.g., using a combination of cameras and/or depth sensors. The user can select a semantic label for the room (e.g., a room name, such as dining room, living room, kitchen, bedroom, etc.). The user can then select a corner of the room to associate with the generated mesh. The XR system can store the generated mesh in association with a location of the designated corner and the semantic label of the room. Upon later entering the room to execute an XR experience, the XR system can attempt to re-localize, e.g., using a newly captured at least partial mesh, attempting to perform mesh matching to previously captured meshes. If re-localization fails, the XR system can prompt the user to select the previously designated corner in the room. Upon selection of the previously designated corner (e.g., using a controller, gaze selection, a gesture, etc.), the XR system can query a database for localization data (e.g., a mesh, spatial anchors, scene data, etc.) associated with the selected corner and/or semantic label. The XR system can then recover the stored localization data, align it according to the location of the selected corner, and render an XR experience relative to the localization data.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the field of artificial reality. In order to render most XR experiences, XR systems need to localize within the real-world space around the XR system. In order to avoid the need to capture localization data each time the space is accessed, the XR system can store localization data. In some previous implementations, the XR system would attempt to access the stored localization data by comparing a newly captured mesh of the real-world space to stored meshes. However, such mesh matching can be highly inaccurate due to the large number of moveable objects within a real-world space. Thus, the XR system would often fail to properly identify the real-world space and recover its previously captured localization data. Thus, the implementations described herein associate the localization data with one or more corners of a room, which are stationary, and therefore are more likely to successfully recover previously captured localization data and more accurately orient the retrieved previous localization data to the real-world room by aligning it to the identified corner. Thus, the user need not recapture localization data for previously accessed spaces (even if mesh matching fails) and can more quickly, accurately, and seamlessly execute an XR experience relative to the recovered localization data. Further, by minimizing redundant recapture of localization data for previously accessed spaces, processing, battery, and storage resources can be conserved on the XR system (and/or on other systems assisting in performing such processes, such as could computing systems storing localization data), and friction and latency in executing the XR experience can be reduced.

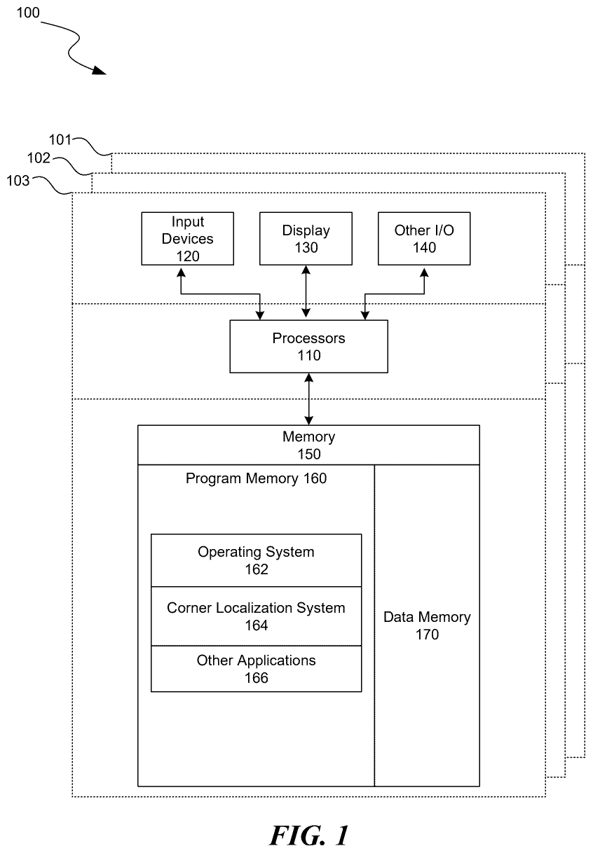

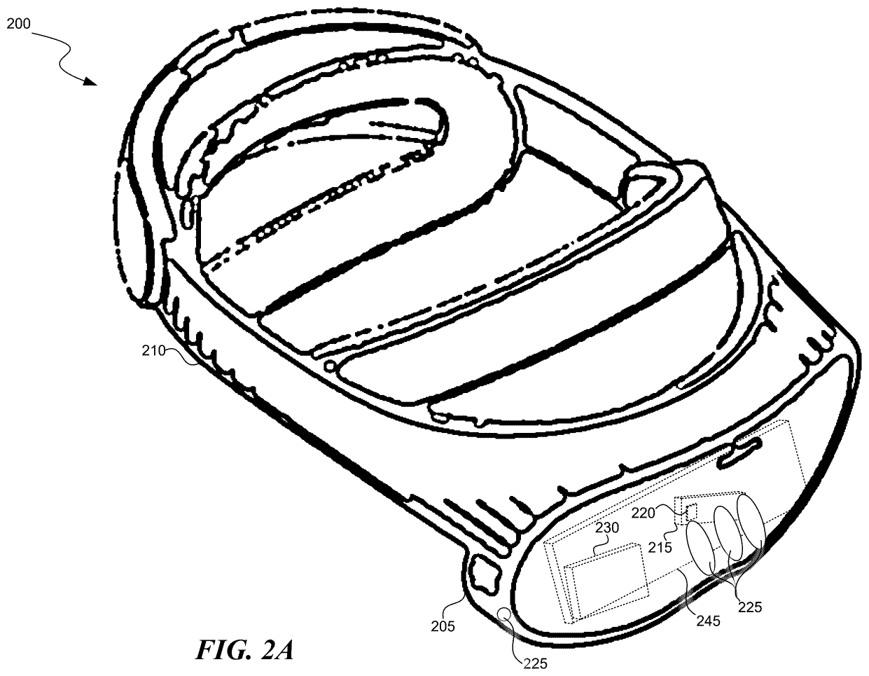

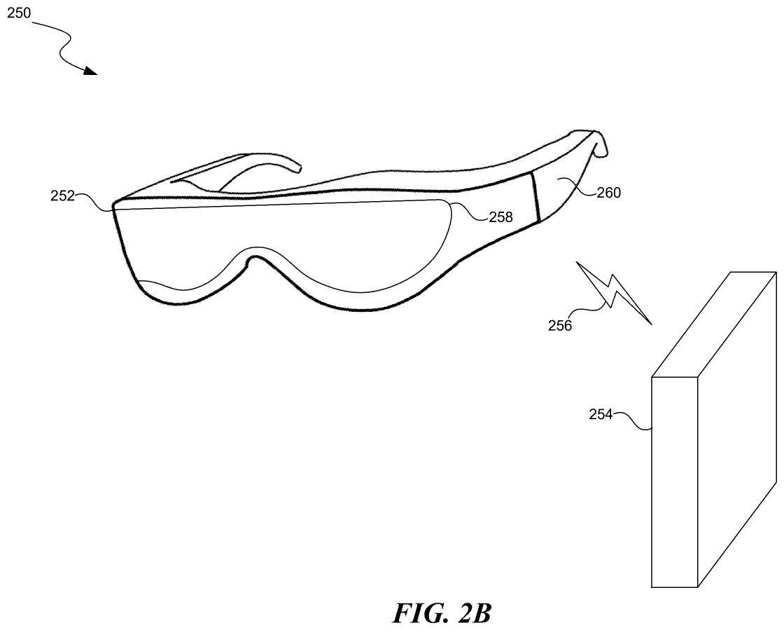

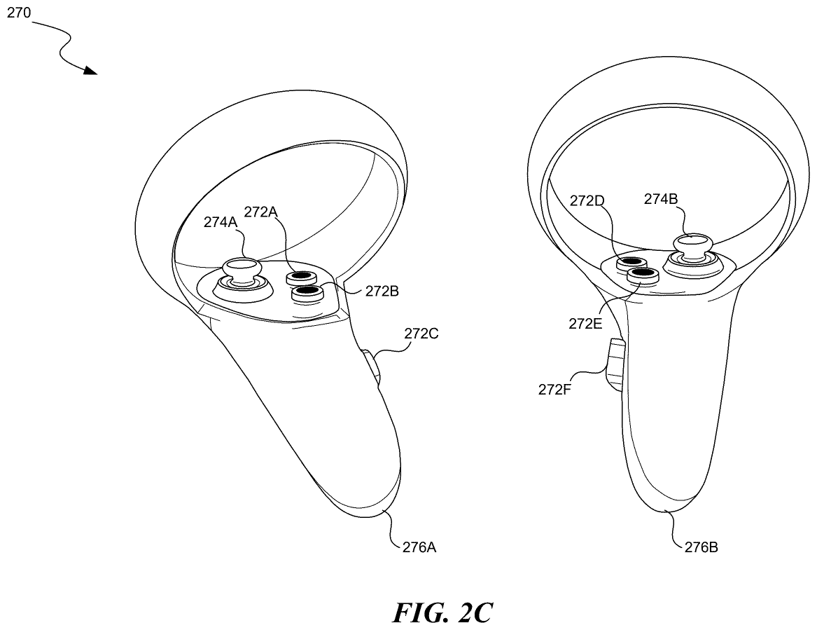

Several implementations are discussed below in more detail in reference to the figures. FIG. 1 is a block diagram illustrating an overview of devices on which some implementations of the disclosed technology can operate. The devices can comprise hardware components of a computing system 100 that can localize an artificial reality (XR) system in a real-world space. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, corner localization system 164, and other application programs 166. Memory 150 can also include data memory 170 that can include, e.g., localization data, corner data, real-world space data, rendering data, semantic label data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

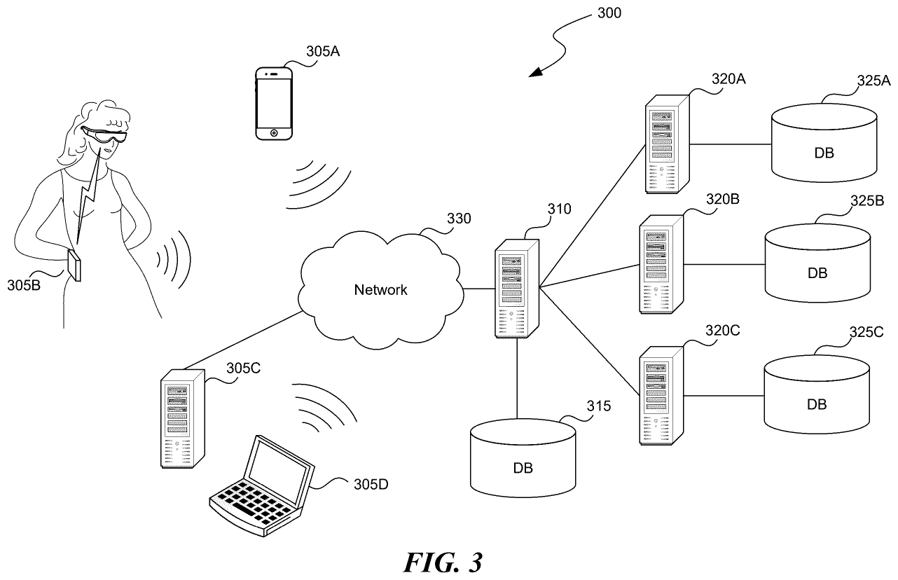

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

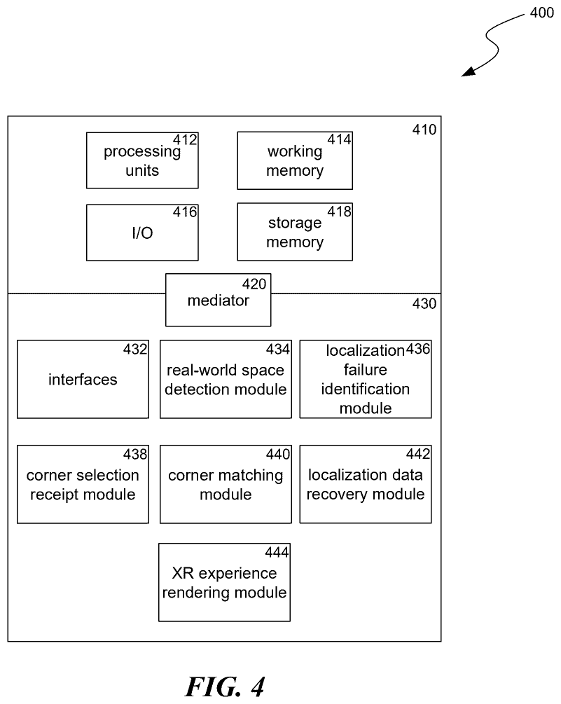

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for localizing an artificial reality (XR) system in a real-world space. Specialized components 430 can include real-world space detection module 434, localization failure identification module 436, corner selection receipt module 438, corner matching module 440, localization data recovery module 442, XR experience rendering module 444, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

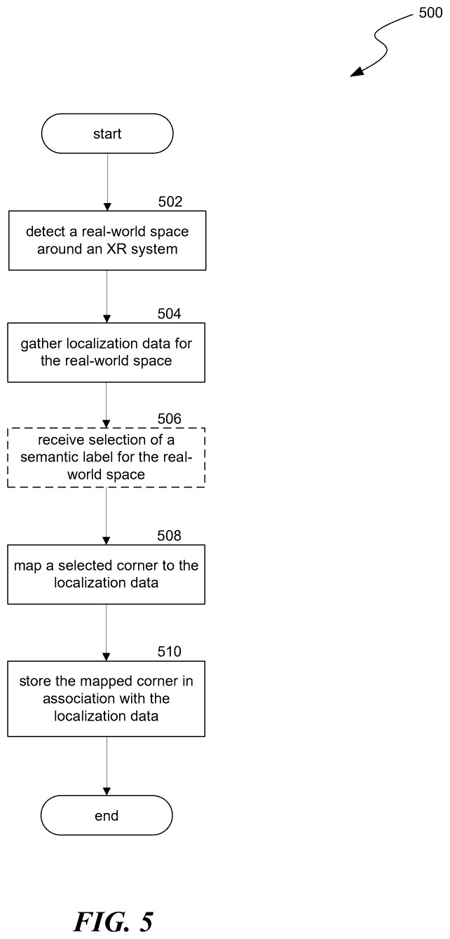

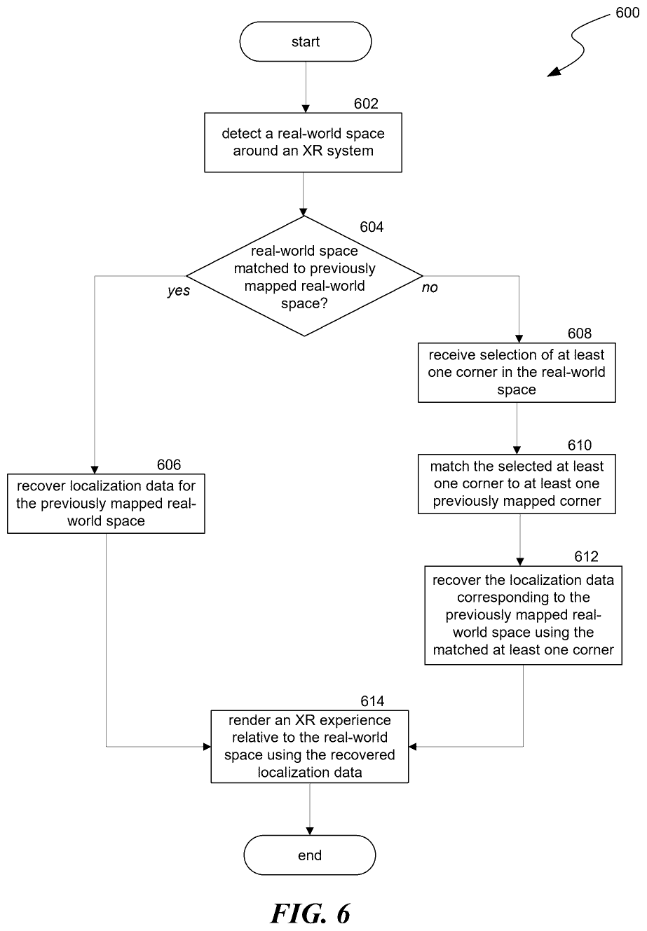

Real-world space detection module 434 can detect a real-world space around the XR system. Real-world space detection module 434 can detect the real-world space upon activation or donning of the XR system, or upon the user of the XR system entering the real-world space. In some implementations, real-world space detection module 434 can detect the real-world space by capturing images of the real-world space using one or more cameras integral with the XR system. In some implementations, real-world space detection module 434 can at least partially identify the floor, ceiling, and walls of at least a portion of the real-world space (e.g., as an XR space model or mesh, as described further herein). In some implementations, upon detecting the real-world space, real-world space detection module 434 can prompt the user to select a semantic label for the real-world space (e.g., a room name). Further details regarding detecting a real-world space around an XR system are described herein with respect to block 502 of FIG. 5 and block 602 of FIG. 6.

Localization failure identification module 436 can determine whether a failure of automatically matching the real-world space to a previously mapped real-world space has occurred. For example, using the XR space model or mesh captured by real-world space detection module 434, localization failure identification module 436 can attempt to match the captured floor, ceiling, and/or walls to previously stored XR space models and/or meshes for previously identified real-world spaces. If localization failure identification module 436 fails to identify a match, localization failure identification module 436 can identify a matching failure. Further details regarding identifying whether a real-world space matches a previously mapped real-world space are described herein with respect to block 604 of FIG. 6.

Corner selection receipt module 438 can receive a selection of at least one corner in the real-world space. In some implementations, the at least one corner can be identified using one or more depth sensors integral with the XR system. The user can remember and select the at least one corner that was previously established and associated with localization data, such as by process 500 of FIG. 5 described herein. In another example, the XR system can automatically select the at least one corner based on a default corner automatically selected by the XR system in set-up, e.g., the furthest corner, the two adjacent corners closest to each other, etc. Further details regarding receiving a selection of at least one corner in a real-world space are described herein with respect to block 608 of FIG. 6.

Corner matching module 440 can match the at least one selected corner to at least one previously mapped corner of a previously mapped real-world space. In some implementations, corner matching module 440 can match the selected corner to the previously mapped corner based on captured depth data for the corner, indicating its location in the real-world space, identified corresponding angles and surfaces, etc. In some implementations in which a single corner is selected, corner matching module 440 can identify two adjacent walls connected to the corner, as well as the floor or ceiling, and match the location and intersection of such walls and floor or ceiling to localization data of a previously mapped real-world space (e.g., a mesh or XR space model). In some implementations in which two adjacent corners are selected, corner matching module 440 can identify two adjacent walls connected to the corner, as well as the floor or ceiling, for each of the two adjacent corners, and match the location and intersection of such walls and floor or ceiling to localization data of a previously mapped real-world space. In some implementations in which two adjacent corners are selected, corner matching module 440 can identify the length of the adjoining wall, and match such a wall, using its length, to localization data of a previously mapped real-world space. Further details regarding matching a selected at least one corner to at least one previously mapped corner of previously mapped real-world spaces are described herein with respect to block 610 of FIG. 6.

Localization data recovery module 442 can recover localization data corresponding to the previously mapped real-world space having the at least one previously mapped corner matched to the selected at least one corner. Localization data recovery module 442 can recover the localization data by, for example, querying a database of localization data stored in association with data identifying the previously mapped corners. In some implementations, localization data recovery module 442 can further recover the localization data by querying the database with the semantic label selected by the user for the real-world space. The localization data can include, for example, mesh data, spatial anchor data, scene data, XR space model data, boundary data, or any combination thereof, as described further herein. Localization data recovery module 442 can then orient the recovered localization data to the current room using the identified corner by aligning the previously identified corner in the localization data to the corner identified by corner matching module 440. Further details regarding recovering and aligning localization data corresponding a previously mapped real-world space having a matching corner with a selected corner are described herein with respect to block 612 of FIG. 6.

XR experience rendering module 444 can render an XR experience, on the XR system, relative to the real-world space, using the recovered localization data. For example, XR experience rendering module 444 can render virtual objects relative to recovered spatial anchors, scene data, and/or mesh data. In some implementations, by recovering previously established spatial anchors for the real-world space, XR experience rendering module 444 can render virtual objects at positions and orientations consistent with previous sessions of the XR experience. In some implementations, XR experience rendering module 444 can display a warning to the user, activate pass-through, display the boundary, etc., when the user of the XR system approaches the boundary recovered by localization data recovery module 442. Further details regarding rendering an XR experience, on an XR system, relative to a real-world space, using recovered localization data are described herein with respect to block 614 of FIG. 6.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5 is a flow diagram illustrating a process 500 used in some implementations for establishing one or more designated corners for localization by an artificial reality (XR) system in a real-world space. In some implementations, process 500 can be performed upon activation or donning of the XR system in a real-world space. In some implementations, process 500 can be performed based on a user-, application-, or system-level request to generate localization data for a real-world space. In some implementations, process 500 can be at least partially performed by the XR system including one or more XR devices, such as an XR head-mounted display (HMD) (e.g., XR HMD 200 of FIG. 2A and/or XR HMD 252 of FIG. 2B), one or more external processing components, etc. In some implementations, process 500 can be at least partially performed by a remote computing system, such as a platform computing system, which can be, e.g., a cloud or edge computing system in some implementations.

At block 502, process 500 can detect a real-world space around the XR system. For example, process 500 can detect the surroundings of the real-world space using one or more cameras and/or other sensors integral with or in operable communication with the XR system. In some implementations, process 500 can detect its surroundings upon activation or donning of the XR system, or from movement of the XR system from one real-world space (e.g., a real-world space known to the XR system) to another real-world space (e.g., a real-world space unknown to the XR system), such as from the user of the XR system crossing the boundary of a known real-world space into another real-world space.

At block 504, process 500 can gather localization data for the real-world space. In some implementations, the localization data can include spatial anchor data. Spatial anchors are world-locked frames of reference that can be created at particular positions and orientations to position content at consistent points in an XR experience, such as manually by a user or automatically by the XR system. Spatial anchors can be persistent across different sessions of an XR experience, such that a user can stop and resume an XR experience, while still maintaining content at the same locations in the real-world environment relative to the spatial anchors.

In some implementations, the localization data can include boundary data. In some implementations, the boundary can be a “guardian.” As used herein, a “guardian” can be a defined XR usage space in a real-world environment. If a user, wearing an XR system, crosses the boundary when accessing an XR experience, one or more system actions or restrictions can be triggered on the XR system. For example, the XR system can display a warning message on the XR system, can activate at least partial pass-through on the XR system, can display the boundary on the XR system, can pause rendering of or updates to the XR environment, etc. In some implementations, the boundary can be manually generated by the user, such as by a user using one or more controllers (e.g., controllers 276A and/or 276B of FIG. 2C) to outline the boundaries of the real-world space (e.g. the accessible floor). In some implementations, process 500 can automatically generate the boundary, e.g., by identifying a continuous floor plane from one or more images captured by one or more cameras using computer vision techniques.

In some implementations, the localization data can include scene data. For example, the XR system can scan the real-world space to specify object locations and types within a defined scene lexicon (e.g., desk, chair, wall, floor, ceiling, doorway, etc.). This scene identification can be performed, e.g., through a user manually identifying a location with a corresponding object type or with a camera to capture images of physical objects in the scene and use computer vision techniques to identify the physical objects as object types. In some implementations, process 500 can store the object types in relation to one or more spatial anchors defined for that area, and/or in relation to an XR space model, as described further below. Further details regarding generating, storing, and using scene data are described in U.S. patent application Ser. No. 18/069,029, filed Dec. 20, 2022, entitled “Shared Scene Co-Location for Artificial Reality Devices” (Attorney Docket No. 3589-0245US01), which is herein incorporated by reference in its entirety.

In some implementations, the localization data can include XR space model data. An XR space model (referred to interchangeably herein as a “room box”) can indicate where the walls, floor, and ceiling exist the real-world space. In some implementations, process 500 can obtain the XR space model automatically. For example, a user of an XR device can scan the real-world space using one or more cameras and/or one or more depth sensors by moving and/or looking around the real-world space with the XR device, and automatically identify one or more flat surfaces (e.g., walls, floor ceiling) in the real-world space using such image and/or depth data. For example, process 500 can identify the flat surfaces by analyzing the image and/or depth data for large areas of the same color, of consistently increasing and/or decreasing depth relative to the XR device, and/or of particular orientations (e.g., above, below, or around the XR device), etc.

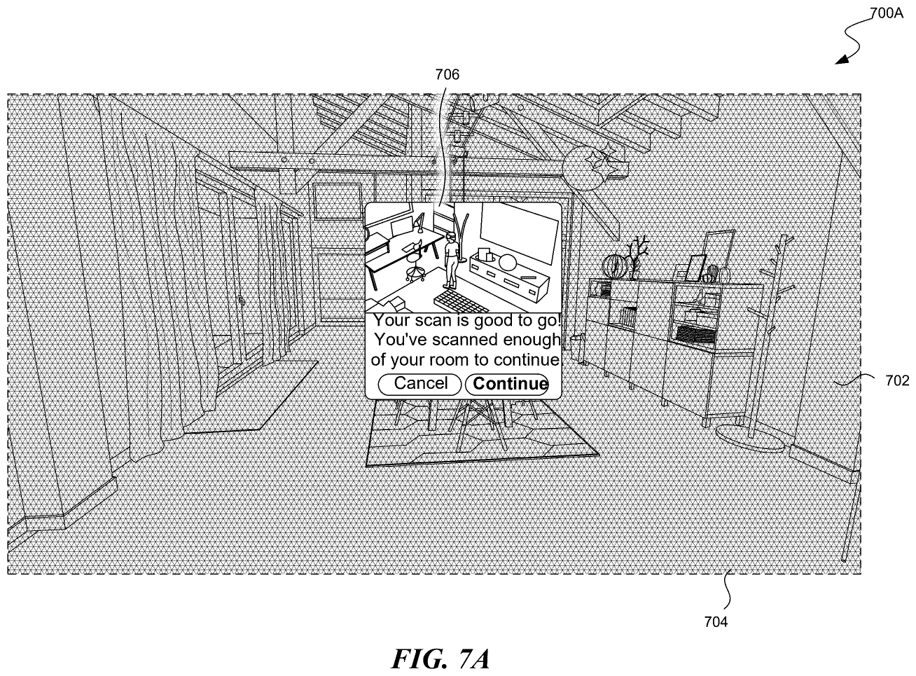

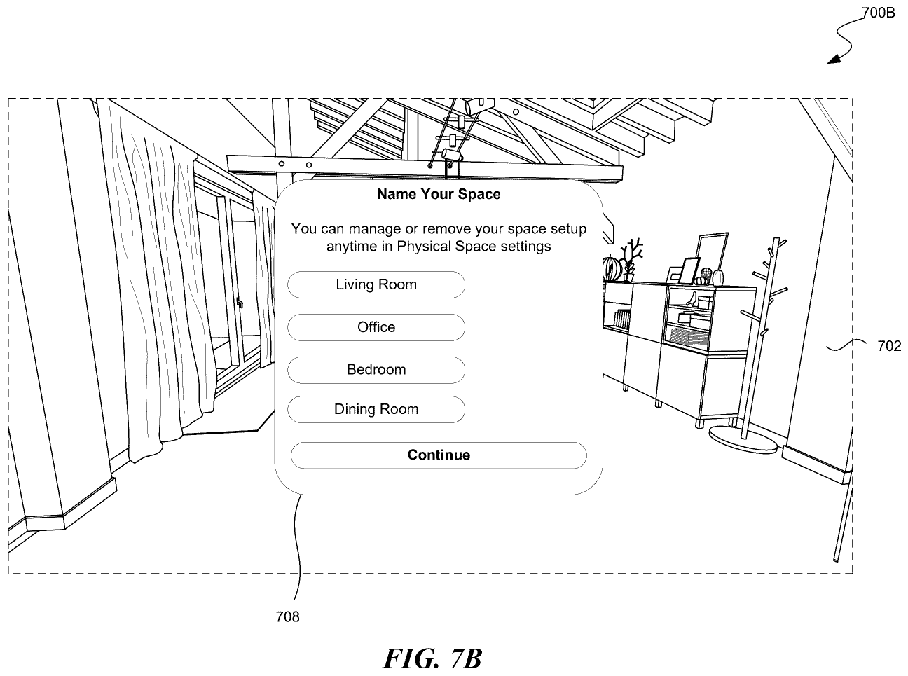

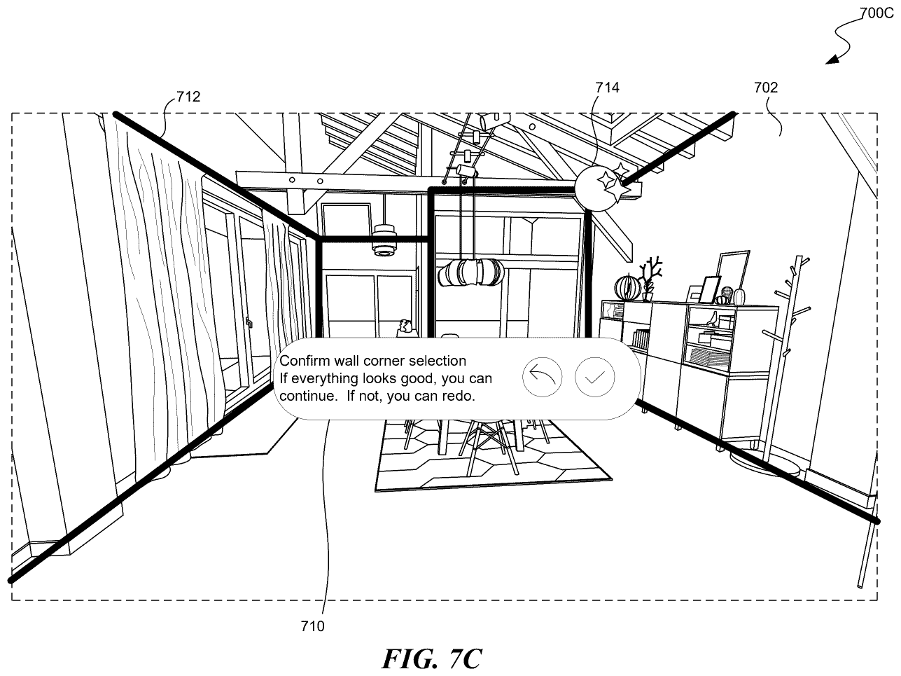

In some implementations, process 500 can capture the XR space model, at least in part, via detected positions of one or more controllers (e.g., controller 276A and/or controller 276B of FIG. 2C) and/or tracked hand or other body part positions. For example, the user of the XR system can move the controllers or body parts around the real-world space to, for example, outline the walls, ceiling, and/or floor with a ray projected from a controller. In another example, the user of the XR system can set the controller or body parts on the walls, ceiling, and/or floor to identify them based on the position of the controller or body part (e.g., as detected by one or more cameras on the XR device, as detected via one or more sensors of an IMU, etc.). In some implementations, process 500 can automatically capture the XR space model, which can then be refined (if necessary) via one or more controllers or body parts as described further herein. An exemplary XR space model is shown and described further herein with respect to FIG. 7B. Further details regarding generating and using XR space models are described in U.S. patent application Ser. No. 18/346,379, filed Jul. 3, 2023, entitled “Artificial Reality Room Capture Realignment” (Attorney Docket No. 3589-0262US01), which is herein incorporated by reference in its entirety.

In some implementations, the localization data can include mesh data generated by scanning the real-world space. The mesh can be, for example, a three-dimensional (3D) model of the boundaries of the real-world space, including one or more walls, the ceiling, the floor, one or more physical objects, etc. In some implementations, process 500 can generate the mesh using one or more cameras, one or more depth sensors, or any combination thereof. In some implementations, however, it is contemplated that depth data need not be captured, and can instead be predicted from the one or more images, such as by a machine learning model. In some implementations, process 500 can further perform post-processing on the mesh to refine and/or simplify the mesh. An exemplary mesh generated by scanning a real-world space with an XR system is shown and described herein with respect to FIG. 7A. Further details regarding generating and using XR space models and meshes are described in U.S. patent application Ser. No. 18/454,349, filed Aug. 23, 2023, entitled “Assisted Scene Capture for an Artificial Reality Environment” (Attorney Docket No. 3589-0286US01), which is herein incorporated by reference in its entirety.

At block 506, in some implementations, process 500 can optionally receive selection of a semantic label for the real-world space, as indicated by the dashed lines. The semantic label can be a conventional name describing a room, such as, for example, “living room,” “bedroom,” “dining room,” “kitchen,” etc. Exemplary semantic labels for a real-world space are shown and described herein with respect to FIG. 7B. In some implementations, however, it is contemplated that block 506 can be omitted, and that process 500 can proceed from block 504 to block 508.

At block 508, process 500 can map one or more selected corners in the real-world space to the localization data. In some implementations in which a semantic label is selected at block 506, the selected corner can further be mapped to the semantic label. In some implementations, process 500 can prompt the user to select a corner in the real-world space via, e.g., by pointing and selecting one or more corners via one or more controllers, by pointing or otherwise gesturing toward one or more corners with a detected hand motion, etc. In some implementations, process 500 can automatically suggest or recommend one or more corners of the real-world space to which to map the localization data, which, in some implementations, can be confirmed by the user. In some implementations, process 500 can suggest or recommend one or more particular corners, such as two adjacent corners on the same wall, or a corner more than a threshold distance away (e.g., furthest away) from a previously established corner of another real-world space. An exemplary view on an XR system of a selected corner to which localization data can be mapped is shown and described herein with respect to FIG. 7C.

At block 510, process 500 can store the one or more mapped corners in association with the localization data, and, optionally, the semantic label. In some implementations, the mapped corner (and/or its associated localization data) can be stored locally on the XR system. However, because the user can use the XR system in many different locations in the real-world environment (e.g., multiple rooms in a home, in other people's homes, etc.), a large amount of corners and/or associated localizations data may need to be stored to consistently render content at those locations, which sometimes cannot be retained locally due to the storage constraints on an XR system. Thus, in some implementations, the mapped corner(s) and/or associated localization data can be stored on a platform computing system on a cloud. Thus, some implementations can conserve storage space on an XR system, as described further in U.S. patent application Ser. No. 18/068,918, filed Dec. 20, 2022, entitled “Coordinating Cloud and Local Spatial Anchors for an Artificial Reality Device” (Attorney Docket No. 3589-0202US01), which is herein incorporated by reference in its entirety.

FIG. 6 is a flow diagram illustrating a process 600 used in some implementations of the present technology for recovering a real-world space using a previously designated corner. In some implementations, process 600 can be performed upon activation or donning of the XR system in a real-world space. In some implementations, process 600 can be performed based on a user-, application-, or system-level request to recover localization data for a real-world space. In some implementations, process 600 can be at least partially performed by the XR system including one or more XR devices, such as an XR head-mounted display (HMD) (e.g., XR HMD 200 of FIG. 2A and/or XR HMD 252 of FIG. 2B), one or more external processing components, etc. In some implementations, process 600 can be at least partially performed by a remote computing system, such as a platform computing system, which can be, e.g., a cloud or edge computing system in some implementations.

At block 602, process 600 can detect the real-world space around the XR system. In some implementations, process 600 can detect the real-world space using one or more cameras and/or one or more other sensors of the XR system, such as to capture images, generate at least a partial mesh and/or XR space model, capture visual features of the real-world space, etc. Process 600 can detect the real-world space either upon activation or donning of the XR system, or upon a user of the XR system entering the real-world space.

At block 604, process 600 can determine whether the real-world space can automatically match the real-world space to a previously mapped real-world space. Process 600 can attempt to match the real-world space to a previously mapped real-world space by any suitable method. For example, process 600 can prompt the user to look around the room, thereby generating a mesh that can be compared with existing room meshes and/or an XR space model that can be compared to existing meshes and/or XR space models. In another example, process 600 can use one or more cameras to capture one or more images of the real-world space and identify visual features of the real-world space (e.g., corners, edges, physical objects, etc.), and compare those visual features to previously captured visual features of known real-world spaces. In still another example, process 600 can capture a localization map including one or more spatial anchors for the real-world space, and determine whether the localization map can be merged or matched to a preexisting localization map including one or more preexisting spatial anchors for the real-world space. Although shown and described as attempting to re-localize in the real-world space by matching the real-world space to a previously mapped real-world space at block 604, it is contemplated that, in some implementations, process 600 need not attempt to re-localize, and can instead proceed directly from block 602 to block 608.

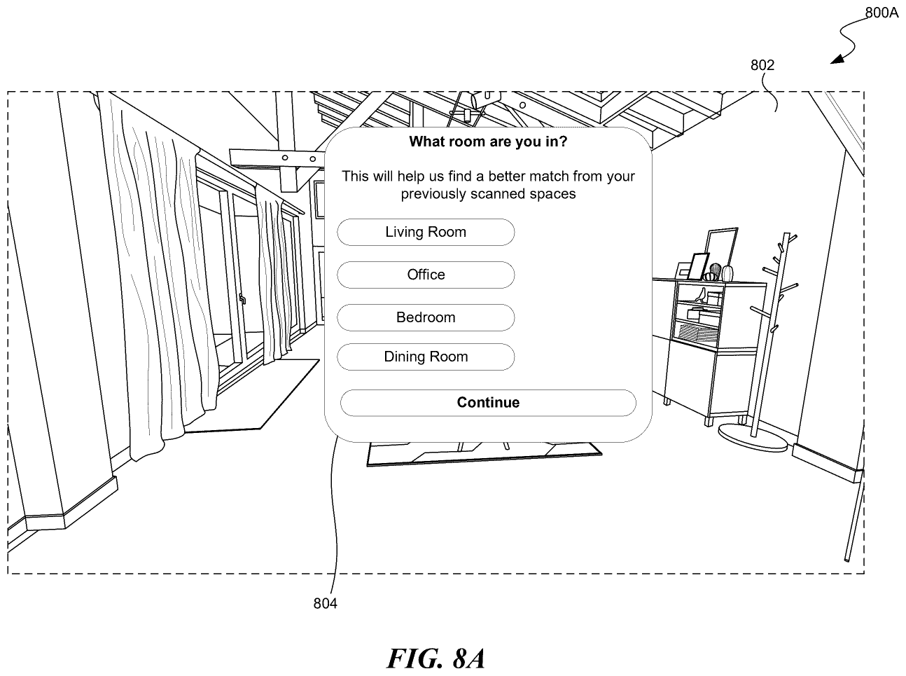

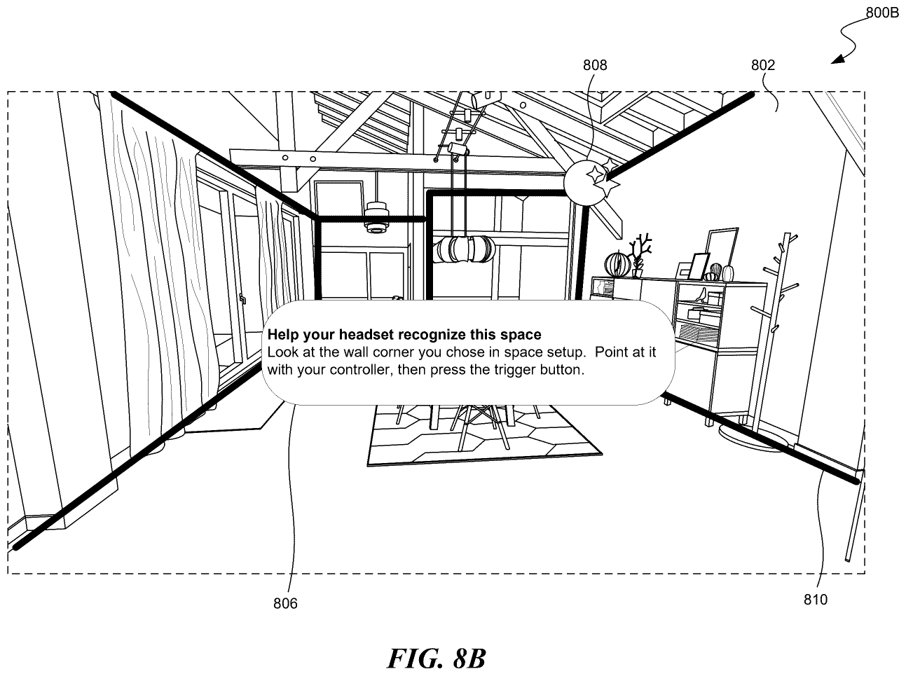

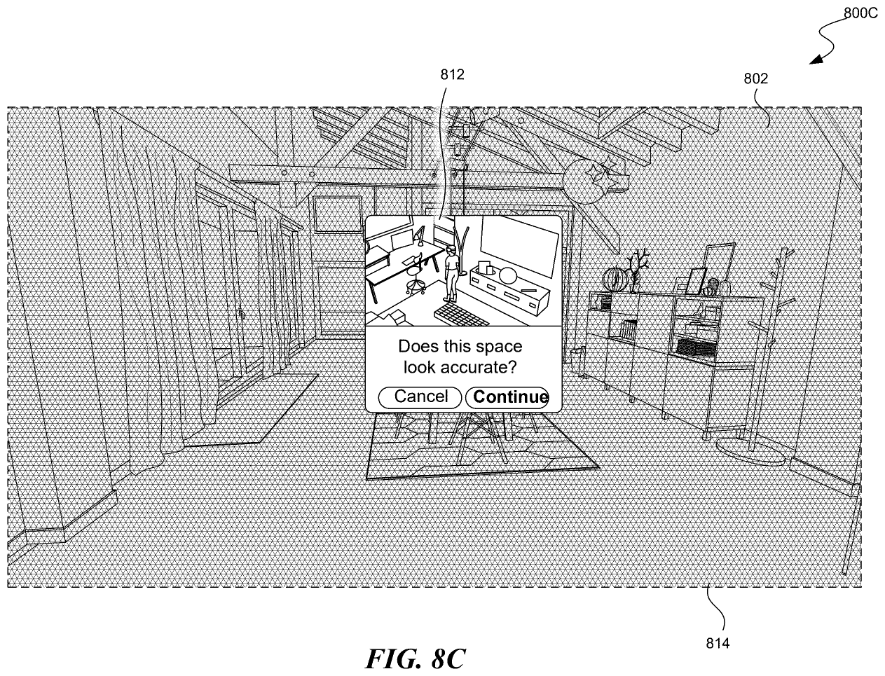

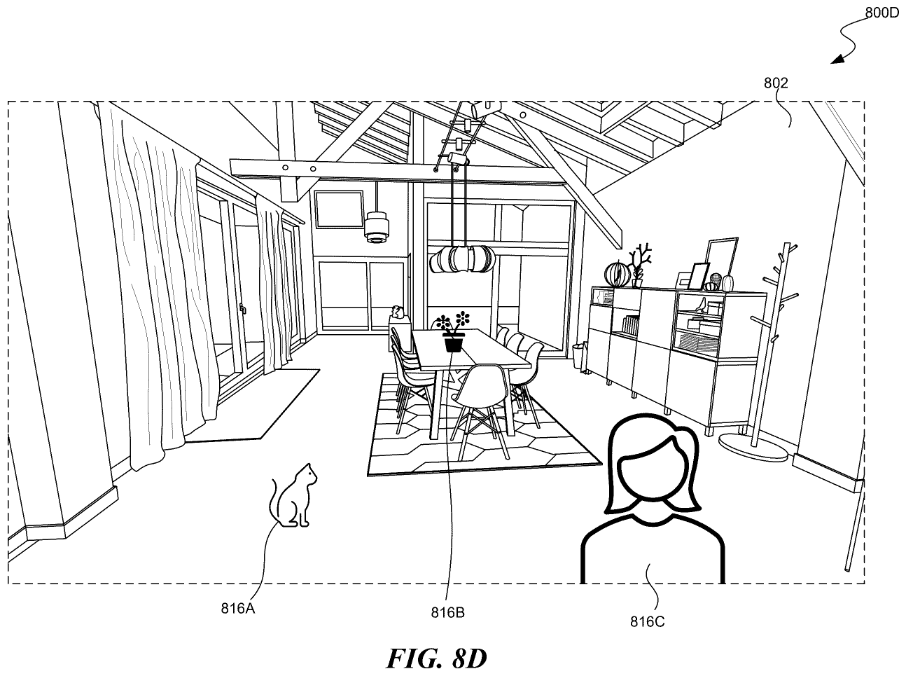

In some implementations, process 600 can prompt the user to select a semantic label for the real-world space. Process 600 can query storage for existing localization data associated with the selected semantic label. If localization data exists associated with the semantic label, process 600 can then attempt to match the existing localization data with data captured for the real-world space, such as by one or more methods described above. An exemplary user prompt for selecting a semantic label for a real-world space is shown and described herein with respect to FIG. 8A.

If, at block 604, process 600 matches the real-world space to a previously mapped real-world space, process 600 can proceed to block 606. At block 606, process 600 can recover localization data for the previously mapped real-world space. For example, if a mesh captured by the XR system matches an existing room mesh, the XR system can align the meshes, and pull existing spatial anchor, scene data, and/or other localization data. In another example, if visual features of the real-world space match previously captured visual features of a known real-world space, process 600 can determine a location of the XR system in the real-world space, and pull existing localization data. In still another example, if a captured localization map can be merged or mapped to a preexisting localization map, process 600 can obtain one or more preexisting spatial anchors (and/or other localization data) for the real-world space. Process 600 can then proceed to block 614.

If, at block 604, process 600 identifies a failure of automatically matching the real-world space to a previously mapped real-world space, process 600 can proceed to block 608. At block 608, process 600 can receive a selection of at least one corner in the real-world space. In some implementations, process 600 can display a mesh and/or XR space model generated at block 602 and/or 604 to facilitate selection of one or more corners of the real-world space. In some implementations, process 600 can identify the selected one or more corners using one or more depth sensors integral with or in operable communication with the XR system. In some implementations, process 600 can suggest or recommend one or more corners of the real-world space for selection. For example, process 600 can suggest one or more default corners, such as corners in locations that are automatically suggested and/or selected by process 500 of FIG. 5 during set up (e.g., the upper right corner, two adjacent corners along the length of a longest wall, etc.). In some implementations, process 600 can automatically select the corner without user input, which can be changed through user selection if localization data is not found at block 610 below. From block 608, process 600 can proceed to block 610.

At block 610, process 600 can match the selected at least one corner to at least one previously mapped corner in the previously mapped real-world space, such as by comparing a location of the selected corner(s), ascertained by comparing a location of the XR system relative to captured depth data for the selected corner(s), to corner location data associated with previously captured corners. Each corner can indicate where two walls and the ceiling or floor meet; thus, in some implementations, from a selected corner, process 600 can match the two walls and ceiling or floor to a previously established mesh for the real-world space. In some implementations, process 600 can match two adjacent selected corners (that were previously set up by process 500) by determining the length of the wall connecting the two corners, and matching the wall to a known wall in a previously established mesh. In some implementations, process 600 can further limit comparison of the selected corner(s) to previously mapped corner(s) associated with a selected semantic label, e.g., a particular room. In some cases, the use of depth sensors to identify corners can be more reliable and detectable than other methods attempting to localize via identified walls of an XR space model and/or mesh, as described further with respect to block 604. Thus, a room that cannot be successfully identified via one or more methods described with respect to block 604 can more easily be identified via matching of corner(s).

The at least one previously mapped corner could have been previously designated for the XR system and associated with localization data for the real-world space, such by process 500 of FIG. 5. The localization data can include at least one of mesh data, spatial anchor data, scene data, XR space model data, boundary data, or any combination thereof, for the real-world space, as described further herein with respect to block 504 of FIG. 5. In some implementations, if the at least one selected corner does not match at least one previously mapped corner, process 600 can prompt the user to select (or automatically select) one or more different corners, and again attempt to match the selected corner(s) to the previously mapped corner(s).

At block 612, process 600 can recover the localization data corresponding to the previously mapped real-world space having the at least one previously mapped corner matched to the selected at least one corner. For example, process 600 can query storage for localization data associated with the previously mapped corner(s), as identified by their location(s) relative to the XR system. In some implementations, process 600 can query a remote computing system (e.g., on the cloud) for the localization data. By storing corner data and/or associated localization data on a cloud (such as for real-world spaces infrequently accessed), the XR system can locally store larger amounts of data needed render the XR application at block 614 below, improving latency and processing speed on the XR system. In some cases, process 600 can align the recovered localization data (with the previously identified corner information) with the real world space by matching the previously identified corner with the corner identified at block 610, which can further speed and improve accuracy for the localization process.

From block 606 or block 612, process 600 can proceed to block 614. At block 614, process 600 can render an XR experience, on the XR system, relative to the real-world space, using the recovered localization data. For example, process 600 can render a virtual reality (VR) experience relative to a recovered boundary for the real-world space. In some implementations, as the user approaches the generated boundary (e.g., comes within a threshold distance and/or moves toward the generated boundary while a threshold amount of velocity) in the real-world space while executing the VR experience, process 500 can display a warning, audibly announce a warning, turn on pass-through, display at least a part of the generated boundary overlaid on the VR experience, or any combination thereof, thereby preventing potential injury to the user (or other users or moveable objects in the real-world space), damage to physical objects in the real-world space, etc.

In some implementations, process 600 can render the XR experience with respect to at least one recovered spatial anchor for the real-world space. In some implementations, process 600 can render one or more virtual objects, overlaid onto the real-world space surrounding the XR device, at positions in the real-world environment relative to the spatial anchors, such as in a mixed reality (MR) or augmented reality (AR) experience. In some implementations, process 600 can render the one or more virtual objects at locations consistent with previously sessions of the XR experience using the recovered one or more spatial anchors. In some implementations, process 600 can render virtual objects relative to recovered scene data, such as identified real-world objects in the real-world space. For example, process 600 can render a virtual vase of flowers on an identified physical kitchen island. In some implementations, process 600 can render virtual objects relative to a recovered mesh. For example, process 600 can render virtual objects relative to and/or interacting with walls, the floor, the ceiling, and/or physical objects identified in the mesh, such as a virtual ball bouncing off of a physical table identified in the mesh. An exemplary view on an XR system of an XR experience rendered with respect to recovered localization data is shown and described herein with respect to FIG. 8D.

FIG. 7A is a conceptual diagram illustrating an example view 700A, on an XR system, of a real-world space 702 scanned by the XR system to establish localization data. Upon detecting real-world space 702 (and, in some implementations, determining that localization data does not already exist for real-world space 702), the XR system can begin scanning the real world space 702, which can include prompting the user to begin looking and/or moving around real-world space 702. As the XR system scans real-world space 702, the XR system can generate and display mesh 704, which can be a three-dimensional (3D) grid overlaid onto view 700A of real-world space 702. In view 700A, mesh 704 can be a grid of interconnected triangles corresponding to the walls, ceiling, floor, and physical objects in real-world space 702. Upon determining that the XR system has scanned more than a threshold amount of real-world space 702 (e.g., 90%), the XR system can display user interface element 706, indicating that the mesh is complete.

FIG. 7B is a conceptual diagram illustrating an example view 700B, on an XR system, of a user interface element 706 for selecting a semantic label for a real-world space 702 scanned by the XR system. In some implementations, upon completion of mesh 704 shown in view 700A of FIG. 7A, the XR system can display user interface element 706, prompting the user to select a semantic label for real-world space 702. For example, for real-world space 702, the user can select that real-world space 702 is a dining room. In some implementations, the selected semantic label can be stored in associated with mesh 704.

FIG. 7C is a conceptual diagram illustrating an example view 700C, on an XR system, of a selection of a corner of a real-world space 702 for localization. As shown in view 700C, in some implementations, the XR system can display XR space model 712 (which can be captured while capturing mesh 704 and/or can be determined from mesh 704), indicating the walls, ceiling, and floor of real-world space 702. As shown in view 700C, the display of XR space model 712 can facilitate identification of corners in real-world space 702 by the user of the XR system. In some implementations, the user can select a corner (e.g., back upper right corner of real-world space 702), which can then be indicated by user interface element 714. In some implementations, the XR system can automatically select a corner, which can then be indicated by user interface element 714. The XR system can then display prompt 710, requesting that the user confirm the selected corner. Upon confirmation, the XR system can store the captured localization data (e.g., mesh 704 and/or XR space model 712) in association with the selected corner and the semantic label selected in view 700B of FIG. 7B.

FIG. 8A is a conceptual diagram illustrating an example view 800A, on an XR system, of a user interface element 804 for selecting a semantic label for a real-world space 802 that fails re-localization. In some implementations, upon determining that the XR system cannot automatically recognize the space, the XR system can query storage for existing localization data associated with the semantic label. In some implementations, the XR system can capture localization data for real-world space 802 in the background while rendering user interface element 804. In some implementations, if localization data exists associated with the semantic label, the XR system can attempt to match the existing localization data with new localization data captured for real-world space 802, such as mesh data or XR space model data, as described further above. In some implementations, the label selection is skipped allowing the user to just select the previously identified corner which can cause the system to gather corner data which is matched to previously stored localization data.

FIG. 8B is a conceptual diagram illustrating an example view 800B, on an XR system, of a user interface element 806 prompting a user to select a previously designated corner in a real-world space. In some implementations, upon activation or donning of the XR system (or upon entering real-world space 802 with the XR system), the XR system can begin to capture localization data for real-world space 802 in an attempt to match real-world space 802 to a previously established space. For example, the XR system can generate XR space model 810. In order to facilitate selection of a corner in real-world space 802, the XR system can display XR space model 810. The user can then use a controller, head or eye gaze direction, and/or a hand gesture to select a corner, e.g., the corner corresponding to user interface element 808. In some implementations, the XR system can render user interface element 808 to suggest which corner was previously set up, e.g., an automatically selected default corner. In some implementations, the XR system can render user interface element 808 to indicate the corner selected by the user.

FIG. 8C is a conceptual diagram illustrating an example view 800C, on an XR system, of a localized real-world space identified via selection of a previously designated corner. Upon matching the corner (indicated by user interface element 808 of FIG. 8B) to the previously designated corner (and/or upon matching the semantic label selected from user interface element 804 of FIG. 8A), the XR system can obtain localization data associated with real-world space 802, including, for example, mesh 814 for real-world space 802. As shown in view 800C, the XR system can align the retrieved localization data, which in some cases is aligned based on matching the user-identified corner to the corner identified in the retrieved localization data, and display mesh 814 overlaid onto real-world space 802, and display user interface element 812 prompting the user to confirm that mesh 814 corresponds to real-world space 802.

FIG. 8D is a conceptual diagram illustrating an example view 800D, on an XR system, of virtual objects 816A-816C rendered relative to localization data obtained for a real-world space 802. Upon selection by the user to execute an XR experience in real-world space 802 (or upon automatic execution of the XR experience upon localization of the XR system), the XR system can render the XR experience shown in view 800D, which can be a mixed reality (MR) or augmented reality (AR) experience in this example. In some implementations, the XR system can render virtual objects 816A-816C relative to physical objects in real-world space 802 identified by mesh 814 of FIG. 8C. For example, the XR system can render virtual cat 816A sitting on the floor identified by mesh 814 and/or other obtained localization data, virtual flower pot 816B sitting on a physical table identified by mesh 814 and/or any available scene data, and avatar 816C in real-world space 802.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for localizing an artificial reality system in a real-world space, the method comprising:
detecting the real-world space around the artificial reality system;
identifying a failure of automatically matching the real-world space to previously mapped real-world spaces;
receiving a selection of at least one corner in the real-world space, the at least one corner identified using one or more depth sensors integral with the artificial reality system;
matching the selected at least one corner to at least one previously mapped corner in the previously mapped real-world spaces,
wherein the at least one previously mapped corner was previously designated for the artificial reality system and associated with localization data for the real-world space, and
wherein the localization data includes at least one of mesh data, spatial anchor data, scene data, artificial reality space model data, boundary data, or any combination thereof, for the real-world space;
recovering the localization data corresponding to the previously mapped real-world space having the at least one previously mapped corner matched to the selected at least one corner; and
rendering an artificial reality experience, on the artificial reality system, relative to the real-world space, using the recovered localization data.

2. The method of claim 1,
wherein the localization data includes the mesh data for the real-world space, and
wherein recovering the localization data includes:
capturing a mesh for the real-world space by scanning the real-world space with the artificial reality system; and
matching the captured mesh to a previously generated mesh stored in the mesh data.

3. The method of claim 1,
wherein detecting the real-world space includes obtaining semantic identification of the real-world space, and
wherein recovering the localization data for the real-world space is further based on the obtained semantic identification of the real-world space.

4. The method of claim 1, wherein the selected at least one corner includes two adjacent corners.

5. The method of claim 4, wherein the method further comprises:
identifying three walls of the real-world space using the two adjacent corners,
wherein recovering the localization data includes:
matching the identified three walls of the real-world space to three previously designated walls identified in the localization data.

6. The method of claim 1, wherein at least one of the at least one previously mapped corner in the previously mapped real-world space was previously designated by a manual selection by a user of the artificial reality system.

7. The method of claim 1, wherein at least one of the at least one previously mapped corner in the previously mapped real-world space was previously designated by an automatic selection by the artificial reality system.

8. The method of claim 1, wherein the localization data is manually adjustable by a user of the artificial reality system.

9. The method of claim 1, further comprising:
displaying at least a portion of the recovered localization data prior to rendering the artificial reality experience.

10. A computer-readable storage medium storing instructions that, when executed by a computing system, cause the computing system to perform a process for localizing an artificial reality (XR) system in a real-world space, the process comprising:
detecting the real-world space around the XR system;
identifying a failure of automatically matching the real-world space to previously mapped real-world spaces;
receiving a selection of a corner in the real-world space, the corner identified using one or more depth sensors;
matching the selected corner to a previously mapped corner in the previously mapped real-world spaces,
wherein the previously mapped corner was previously designated for the XR system and associated with localization data for the real-world space, and
wherein the localization data includes at least one of mesh data, spatial anchor data, scene data, artificial reality space model data, boundary data, or any combination thereof, for the real-world space;
recovering the localization data corresponding to the previously mapped real-world space having the previously mapped corner matched to the selected corner; and
rendering an XR experience, on the XR system, relative to the real-world space, using the recovered localization data.

11. The computer-readable storage medium of claim 10,
wherein the localization data includes the mesh data for the real-world space, and
wherein recovering the localization data includes:
capturing a mesh for the real-world space by scanning the real-world space with the XR system; and
matching the captured mesh to a previously generated mesh stored in the mesh data.

12. The computer-readable storage medium of claim 10,
wherein detecting the real-world space includes obtaining semantic identification of the real-world space, and
wherein recovering the localization data for the real-world space is further based on the obtained semantic identification of the real-world space.

13. The computer-readable storage medium of claim 10, wherein the previously mapped corner was previously designated by a manual selection by a user of the XR system.

14. The computer-readable storage medium of claim 10, wherein the previously mapped corner was previously designated by an automatic selection by the XR system.

15. The computer-readable storage medium of claim 10, wherein the localization data is manually adjustable by a user of the XR system.

16. The computer-readable storage medium of claim 10, wherein the process further comprises:
displaying at least a portion of the recovered localization data prior to rendering the XR experience.

17. A computing system for localizing an artificial reality (XR) system in a real-world space, the computing system comprising:
one or more processors; and
one or more memories storing instructions that, when executed by the one or more processors, cause the computing system to perform a process comprising:
detecting the real-world space around the XR system;
identifying a failure of automatically matching the real-world space to previously mapped real-world spaces;
receiving a selection of two corners in the real-world space, the two corners identified using one or more depth sensors;
matching the selected two corners to two previously mapped corners in the previously mapped real-world spaces,
wherein the two previously mapped corners were previously designated for the XR system and associated with localization data for the real-world space;
recovering the localization data corresponding to the previously mapped real-world space having the two previously mapped corners matched to the selected two corners; and
rendering an XR experience, on the XR system, relative to the real-world space, using the recovered localization data.

18. The computing system of claim 17, wherein the localization data includes at least one of mesh data, spatial anchor data, scene data, artificial reality space model data, boundary data, or any combination thereof, for the real-world space.

19. The computing system of claim 17, wherein the selected two corners are adjacent.

20. The computing system of claim 19, wherein the process further comprises:
identifying three walls of the real-world space using the selected two corners, wherein recovering the localization data includes:
matching the identified three walls of the real-world space to three previously designated walls identified in the localization data.
